(19) United States
(12) Patent Application Publication
(10) Pub. No.: US 2006/0266189 A1
(43) Pub. Date: Nov. 30, 2006

(54) Saw blade angular adjustment device for a metal and wood cutting machine

(76) Inventor: Yuehting Chen, Fongyuan City (TW)

Correspondence Address: CHEN, YUEHTING, P.O. Box 697, Fongyuan City, Taichung County, 420, TW

(21) Appl. No.: 11/138,337

(22) Filed: May 27, 2005

(51) Int. Cl. B26D 5/08

(52) U.S. Cl. 83/581

(57) ABSTRACT

A saw blade angular adjustment device for a metal and wood cutting machine includes a rectangular working platform having a pair of symmetrically arranged triangular support arms on lateral sides each including a screw hole in the top engaged with an arcuate slit in the middle portion of a pair of pillow shaped pivotal plates which is rotatably secured to the arms by bolt, a pair of sliding bars parallel secured to the top of the pivotal plates, a saw blade angular adjustment assembly slidably engaged onto the sliding bars including a seat and a guarded saw bladed which is operated by a motor inside the seat a pair of first and second clamping plate parallel disposed on the front portion of the platform and a pair of U-shaped rods respectively inserted into the front and rear end of the platform. The feature is that both of the saw blade and the clamping plate can be adjusted a certain degree of angle.

### BACKGROUND OF THE INVENTION

The present invention relates to stone cutting machine and more particularly to a saw blade adjustment device for a metal and wood cutting machine.

It is known that a portable metal cutter can cut metallic rods, metallic plates and/or a metallic block at working site. It is very convenient to the worker who uses the machine. Due to the platform is plane and perpendicular to the saw blade. The cutting result should perpendicular too. If the worker tries to cut an oblique edge, he must cutting a perpendicular edge at first. Then cutting oblique edge. However, the oblique edge is scarcely acceptable. So the worker has to try more and more. But the results are still not actuate except waste time and labor.

The conventional cutting machine has also the same defect. The applicant in accordance with the aforediscussed effects studies again and again, finally worked out the saw blade angular adjustment device for the metal and wood cutting machine.

### SUMMARY OF THE PRESENT INVENTION

The present invention has a main object to provide a saw blade angular adjustment device for a metal and wood cutting machine which is portable and quickly decides a angle toward the cutting platform and quickly turns it back to the original position, Everytime positioning a single accurate angle.

Accordingly, the saw blade angular adjustment device for a metal and wood cutting machine comprises generally a cutting platform having a pair of support arms on two lateral edges each including a positioning through hole in a top for pivotally connected a pair of pivotal plates each of which has an arcuate slit in the center, a through hole connected to the cutting platform by bolt, the arcuate slit are connected to the positioning hole of support plate by a pair swivel buttons. The top of the pivotal plates connects to a pair of sliding rods.

A pair of movable clamp plates parallel disposed on the platform for clamping the working pieces.

A cutting assembly has a guarded saw blade at front end and a displacement seat at underside including a pair of parallel tube in two lateral edges slidably engaged with the pair of sliding rods on the pivotal plates on which the cutting assembly is slid. The platform has a slot to dispose the saw blade which cuts the metal and/or the wood.

In operation, be center with a through hole of the pivotal plates and adjusts the pivotal plates together with the saw blade for a certain oblique angle to obliquely cut the working pieces.

The present invention will become more fully understood by reference to the following detailed description thereof when read in conjunction with the attached drawings.

### BRIEF DESCRIPTION OF THE DRAWINGS

FIG. 1 is an exploded perspective view to show the preferred embodiment of the cutting machine of the present invention,

FIG. 2 is a perspective view to show the assembly of FIG. 1,

FIG. 3 is a perspective view to show that the saw blade is perpendicularly cutting a working piece,

FIG. 4 is a side plane view looking from a different direction,

FIG. 5 is a plane view to show the saw blade being obliquely cutting a working piece,

FIG. 6 is a perspective view to show the saw blade being obliquely cutting a work piece,

FIG. 7 is a top plane view indicating the U-shaped bar and the pair of oblique clamping plates being pulling out, and

FIG. 8 is a top plane view showing the pair of the clamping plates that are returned to its original position.

### DETAILED DESCRIPTION OF THE PREFERRED EMBODIMENT

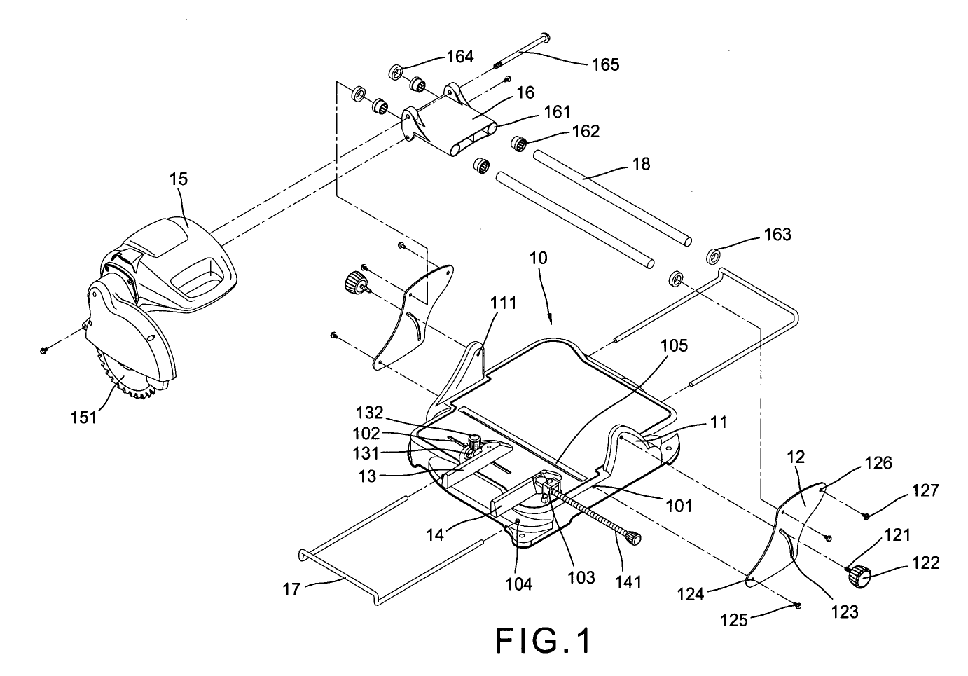

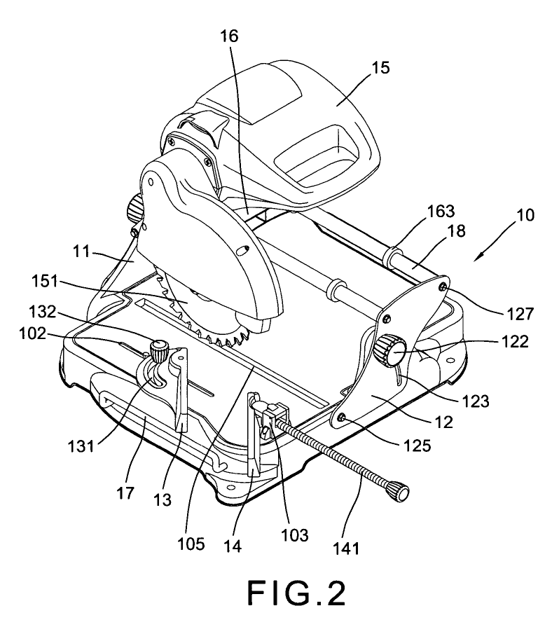

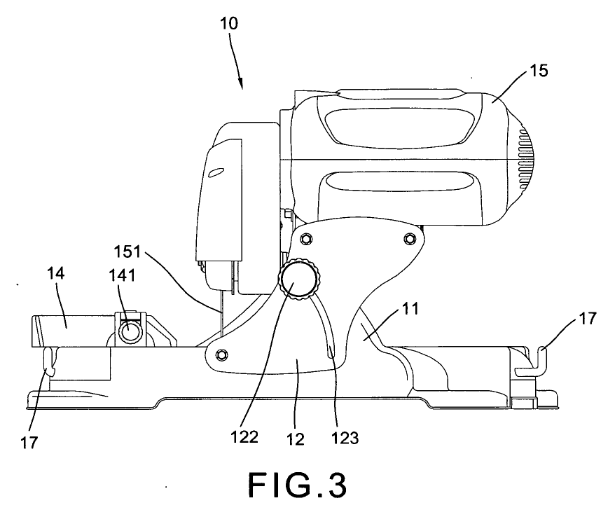

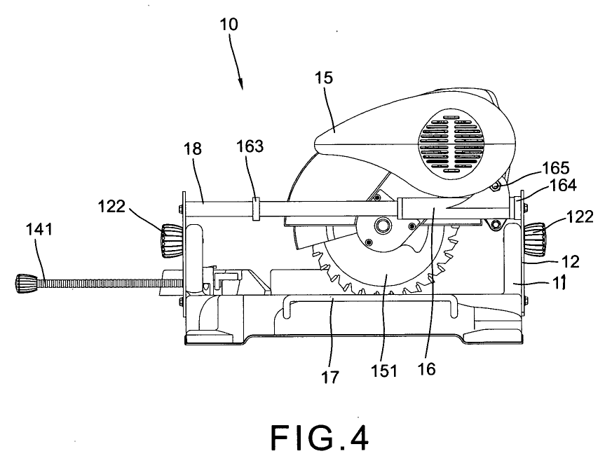

With reference to the drawings and initiated from FIGS. 1 to 4, the saw blade angular adjustment device for a metal and wood cutting machine of the present invention comprises a working platform 10 which has a pair of symmetrical triangular support arms 11 projected upward for two lateral edges each having a screw hole 111 adjacent the top for respectively fastening an arcuate slit 123 in the middle portion of a pair of pillow shaped pivotal plates 12 by threaded shanks 121 of the swivel buttons 122, a pair of clamping plate 13 and 14 movably and parallel disposed on a front top of the platform 10, a saw blade angular adjustment assembly 15 having a guarded saw blade 151 on one end, a displacement seat 16 on underside fastened by a long bolt 165 and a screw 161. The displacement seat 16 having a pair of tubes 161 in two lateral edges slidable on a pair of sliding bars 18 parallel connected to the top of the pair of the pillow shaped pivotal plates 12 by screws 127 through the screw holes 126 and reinforced by the sliding rings 162 and stop rings 163 and 164, a pair of U-shaped rods respectively inserted into the insertion holes in front and rear end of the platform 10 which can be pulling outward when the working piece is too big to be supported by the platform 10 itself. The platform 10 further has a horizontal cutting groove 105 in a surface adjacent the clamping plates 13 and 14 across the top of the platform 10 for engaging with the saw blade which is operated by a motor in the seat of the assembly 15 (not shown), the clamping plate 13 is integrated with a part of graduator 131, a short sliding groove 102 under the part of graduator 131 so as to slidably connect the clamping plate 13 with the sliding groove 102 by a bolt 132. The clamping plate 14 has a positioning block 103 near the inner end including threaded screw hole in the center for engaging within a long threaded shank of a bolt 141. The clamping plate 13 is displaceable by the bolt 132 and clamping plate 14 is operated by the bolt 141 which may turn the clamping plate 14 for an angle. So that the pair of clamping plates 13 and 14 can be able to clamp a working piece obliquely. The through holes 104 in two end of the platform 10 is receiving the U-shaped rods 17 for supporting large working piece.

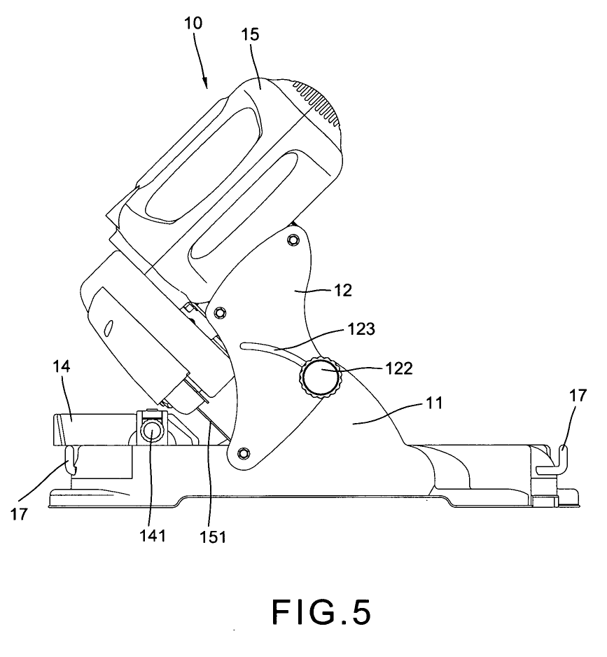

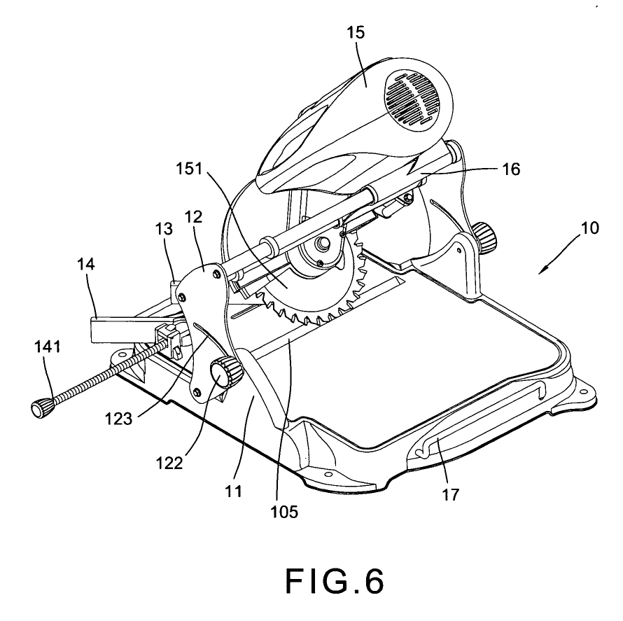

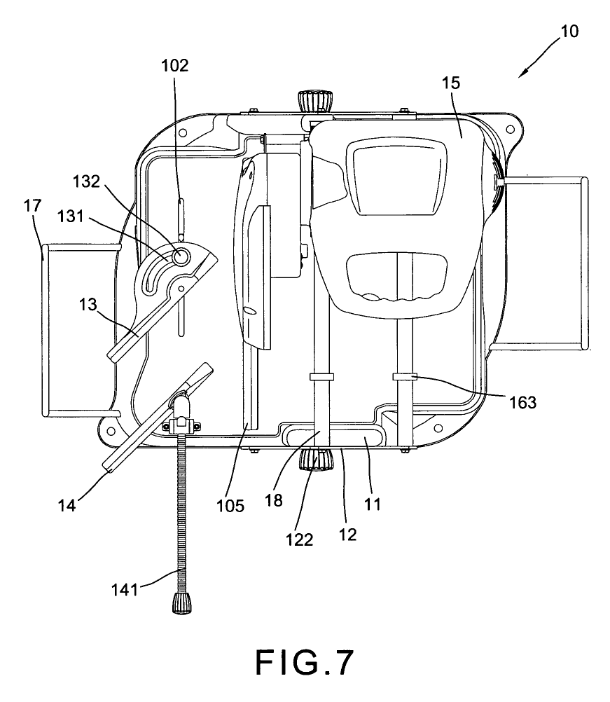

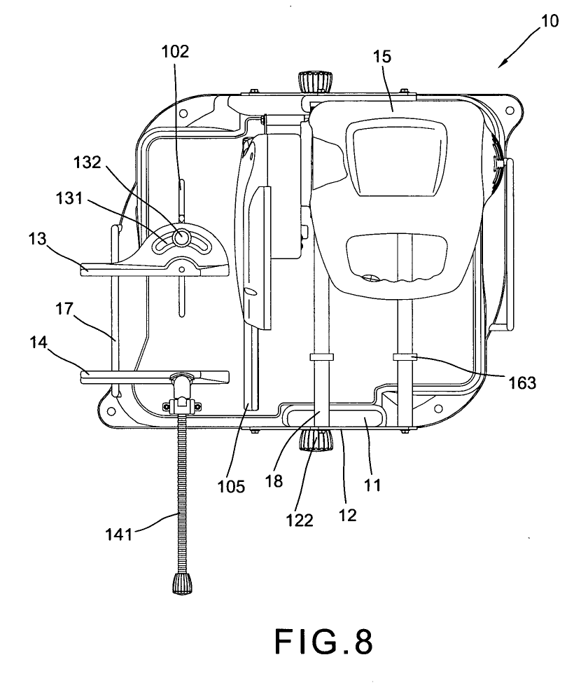

Referring to FIGS. 5 and 6, upon the aforediscussed structure, the saw blade 151 is normally perpendicular to the top plane of the platform 10 so as to perform normal cutting of the working piece. The saw blade is pushed from one side to the other side. However, the pair of the clamping plates 13 and 14 can be oblique to consist with the shape of the working piece. But if wants to cut a sloped edge, the operator may unfasten the bolt 122 which slide downward along the arcuate slit 123 until a desired angle is found out, then fastens the bolt 122 again the saw blade will be oblique a certain angle which is measured by the part of graduator 131. Note that if the bolt 122 is positioned on the up most position of the arcuate slit 123, the saw blade 151 is perpendicular to the surface of the platform 10. Contrarily, if the bolt 122 is at the lowermost position, the surface of the saw blade 151 is 45° relative to the platform surface. Sometimes, the working piece is too big to support by the platform 10, the U-shaped rods 17 is useful to draw out of the platform 10 (as show in FIGS. 7 and 8). Once the bolt 122 is fastened, it will not be automatically loosened. So that the cutting result is reliable.

Note that the specification relating to the above embodiment should be construed as an exemplary rather than as a limitative of the present invention, with many variations and modifications being readily attainable by a person of average skill in the art without departing from the spirit or scope thereof as defined by the appended claims and their legal equivalents.

I claim:

1. A saw blade angular adjustment device for a metal and wood cutting machine comprising:
a rectangular working platform having a pair triangular support arms symmetrically and respectively projected upward from lateral edges and each including a screw hole adjacent top, a horizontal cutting groove in the surface across front portion, a short slit in front and parallel to said horizontal cutting groove, a pair of first and second clamping plates parallel disposed abutting front end, wherein said first clamping plate integrates with a part graduator slidably engaged with said short slit by a bolt, said second clamping plate has a positioning block including threads in center engaged with a long threaded shank of a bolt which operating said second clamping plate to turn a horizontal angle and a pair through hole spacedly formed in front and rear end thereof;
a pair of pillow shaped pivotal plates each having a pair of screw hole respectively formed in upper corners, a single screw hole in a lower corner and an arcuate slit in a center engaged with the screw holes of said triangular supper arms and fastened by a bolt; wherein the screw hole in the lower corner thereof fastens to a pair of screw holes in lateral edges of said platform by screws;
an angular adjustment saw assembly having a seat, a guarded saw blade on end of the seat and operated by a motor inside the seat, a displacement plate secured to underside of the seat by a bolt and a screw including a pair of sliding tubes in two lateral sides for respectively engaging on a pair of sliding bars which are parallel secured on their ends with the screw holes in upper corners of said pillow shaped pivotal plates by screws with a plurality of sliding rings and stopping rings engaged therebetween;
a pair of U-shaped rods respectively engaged within the through holes in front and rear side of said platform;
whereby, operate the bolt of the pivotal plate to adjust the saw blade for a certain angle and operate the long bolt to adjust the horizontal angle for the clamping plates.

2. The saw blade angular adjustment device as recited in claim 1, wherein said U-shaped rod is provided to support a large working piece.
